(19) United States
(12) Patent Application Publication
(10) Pub. No.: US 2012/0099060 A1
(43) Pub. Date: Apr. 26, 2012

(54) LIQUID CRYSTAL DISPLAY ELEMENT AND LIQUID CRYSTAL DISPLAY DEVICE

(76) Inventors: Toshihiro Matsumoto, Osaka (JP); Mitsuhiro Murata, Osaka (JP); Yuichi Kawahira, Osaka (JP)

(21) Appl. No.: 13/380,960

(22) PCT Filed: Mar. 5, 2010
(86) PCT No.: PCT/JP2010/001542

§ 371 Date: Dec. 27, 2011

(30) Foreign Application Priority Data
Jul. 1, 2009 (JP) 2009-157131

(51) Int. Cl. G02F 1/1335; G02F 1/1337

(52) U.S. Cl. 349/106; 349/123

(57) ABSTRACT

A vertical alignment type liquid crystal display element (10) which carries out display operation by controlling orientations of liquid crystal molecules (52) by use of transverse electric fields, wherein interleaved electrodes (30) are provided on an array substrate (22), and a thickness (dl) of a liquid crystal layer (50) at portions where the interleaved electrodes (30) are provided is larger than a thickness (ds) of the liquid crystal layer (50) in an inter-electrode area (RS).

### TECHNICAL FIELD

The present invention relates to a liquid crystal display element and a liquid crystal display device, both of which are improved so that display quality deterioration caused by pressing a surface of a liquid crystal panel is reduced.

### BACKGROUND ART

A liquid crystal display device, in which a liquid crystal display element is used as a display section of the liquid crystal display device, is characterized by being thin, light, and low in power consumption and widely used in various fields.

For such a liquid crystal display element, a viewing angle characteristic and a response speed can be exemplified as problems it has to overcome. In the liquid crystal display element, a display characteristic changes in accordance with a viewing angle. This is because the liquid crystal molecules have a rod-like shape. The rod-like shape results in that the liquid crystal display element shows different states of birefringence when viewed from the front and when viewed obliquely.

In view of the above, various techniques have been proposed in order to improve liquid crystal display elements in viewing angle characteristic and response speed.

### Patent Literature 1

For example, Patent Literature 1 as listed below discloses a technique for increasing a response speed in a liquid crystal display device of a transverse electric field type, in which liquid crystal display device a pixel electrode and a counter electrode are provided on a single substrate. In the technique, a liquid crystal layer is thicker on at least one of the pixel electrode and the counter electrode than on an area between the pixel electrode and the counter electrode, or the like.

### Citation List

### Patent Literature

Patent Literature 1

Japanese Patent Application Publication, Tokukai, No. 2002-40400 A (Publication Date: Feb. 6, 2002)

### SUMMARY OF INVENTION

### Technical Problem

However, the technique as disclosed in Patent Literature 1 has the following problem. That is, it is difficult to form in a counter substrate a depressed portion above the pixel electrode or the counter electrode so as to thicken the liquid crystal layer at the depressed portion. This is because (i) the electrodes in general have a small width and (ii) the two substrates are sometimes attached to each other with misalignment.

### Vertical-Alignment Transverse-Electric-Field Mode

To improve the viewing angle characteristic, increase the response speed, and the like, various display modes have been proposed, such as a display mode using a transverse electric field and a display mode using vertically aligned liquid crystal molecules, for example.

Among the various display modes is a vertical-alignment transverse-electric-field mode, which is a display mode using vertically aligned liquid crystal molecules and a transverse electric field. In the vertical-alignment transverse-electric-field mode, positive liquid crystals or negative liquid crystals are vertically aligned and (ii) liquid crystal molecules are caused to move (tilted) by means of a transverse electric field generated between interleaved electrodes provided on one of substrates. This controls an amount of light that transmits through a liquid crystal panel during displaying.

The liquid crystal panel of the vertical-alignment transverse-electric-field mode has little change in transmittance even if a pressing force (pressure or the like which is generated when the liquid crystal panel is pressed with a finger or the like) is applied to the liquid crystal panel. As a result, little display unevenness is observed in the liquid crystal panel. This is because the liquid crystal molecules in the liquid crystal panel of the vertical-alignment transverse-electric-field mode are in a bend orientation when observed in a cross-sectional view of the liquid crystal panel. The bend orientation optically has a self-compensation effect, which can prevent an optical change even if the applied pressing force causes a change in cell thickness of the liquid crystal panel (i.e., a thickness of the liquid crystal layer) and the change in cell thickness causes distortion in the orientation of the liquid crystal molecules.

However, in a case where the liquid crystal panel is pressed hard, the self-compensation of the bend orientation tends to be reduced and the change in transmittance caused by the pressing force tends to increase accordingly.

This is because the pressing force of the liquid crystal panel with high pressure significantly reduces the cell thickness. The reduced cell thickness makes it impossible to compensate for the change in cell thickness by means of the self-compensation of the bend orientation. As a result, the liquid crystal molecules cannot stay in the bend orientation, whereby the orientations of the liquid crystal molecules become no longer symmetrical.

The change in transmittance tends to be perceived as display unevenness and therefore cause degradation in display quality.

In addition, even if the depressed portion as described in Patent Literature 1 is applied to the vertical-alignment transverse-electric-field mode, it is impossible to prevent generation of the display unevenness that is caused by the pressing force.

The present invention is accomplished in view of the aforementioned problem. An object of the present invention is to provide a liquid crystal display device and a liquid crystal display element of a vertical-alignment transverse-electric-field mode, in which generation of display unevenness caused by pressing a liquid crystal panel is reduced and which thus has high display quality.

### Solution to Problem

In order to attain the object, a liquid crystal display element of the present invention is a liquid crystal display element which is a vertical alignment type liquid crystal display element including a pair of substrates, and a liquid crystal layer sandwiched between the substrates and being configured to carry out display operation by controlling orientations of liquid crystal molecules in the liquid crystal layer by use of transverse electric fields, including: interleaved electrodes on at least one of the substrates, the liquid crystal layer having a thickness which is smaller at a portion where each of the interleaved electrodes is provided than at a portion where none of the interleaved electrodes is provided.

According to the configuration, in the liquid crystal display element of the vertical-alignment transverse-electric-field mode, the liquid crystal layer has a smaller thickness at the portion where each of the interleaved electrodes is provided than at the portion where none of the interleaved electrodes is provided. As such, an insensitive area, which is an area in which an electric field has low intensity and the liquid crystal molecules are not tilted to a great extent, exists in the liquid crystal layer at the portion where none of the interleaved electrodes is provided.

The insensitive area has a small retardation (Δnd), because the liquid crystal molecules in the insensitive area are not tilted to a great extent in a case where a pressing force is not applied to the liquid crystal display element. As such, the insensitive area is not apt to affect display quality.

In comparison, in a state where a pressing force has been applied to the liquid crystal display element, deformation is generated in the liquid crystal display element. The deformation causes the liquid crystal molecules in the insensitive area to be tilted. This increases the retardation in the insensitive area.

However, since the liquid crystal display element has a structure in which the liquid crystal layer has a smaller thickness at the portion where each of the interleaved electrodes is provided than at the portion where none of the interleaved electrodes is provided, increase in retardation in the insensitive area, which increase is caused by a pressing force applied to the liquid crystal display element, is smaller than that in a case in which the liquid crystal display element does not have the structure. Accordingly, it becomes easier to maintain an optimum retardation. Therefore, even in a case where a pressing force is applied to the liquid crystal display element, a change in transmittance is prevented and display unevenness is prevented.

The prevention of the change in transmittance, which change occurs when a pressing force is applied, in the configuration will be described below from a different viewpoint. In the liquid crystal display element of the vertical-alignment transverse-electric-field mode, the liquid crystal molecules are oriented symmetrically with respect to an axis of symmetry, which is in a substantially central portion (a center line between the interleaved electrodes) in an area between the interleaved electrodes adjacent to each other. According to the configuration, a thickness of the liquid crystal layer in the area between the interleaved electrodes than a thickness of the liquid crystal layer on the interleaved electrodes. As such, even in a case where a pressing is applied to the liquid crystal display element so that deformation is generated in the liquid crystal display element, symmetry is likely to be maintained in the orientations of the liquid crystal molecules in the area between the interleaved electrodes. This reduces a difference in amount of transmitted light between a portion where the pressing force is applied and a portion where the pressing force is not applied. Accordingly, an occurrence of display unevenness is prevented.

Thus, the configuration makes it possible to provide a liquid crystal display element of a vertical-alignment transverse-electric-field mode with high display quality by preventing display unevenness caused when the liquid crystal panel is pressed.

### ADVANTAGEOUS EFFECTS OF INVENTION

As described above, the liquid crystal display element of the present invention is arranged such that (i) interleaved electrodes are provided on at least one of said first substrate and said second substrate and (ii) the liquid crystal layer has a smaller thickness at a portion where each of the interleaved electrodes is provided than at a portion where none of the interleaved electrodes is provided.

This makes it possible to provide a liquid crystal display element having high display quality by preventing display unevenness caused when the liquid crystal panel is pressed.

### BRIEF DESCRIPTION OF DRAWINGS

FIG. 1

FIG. 1 is a view of a general configuration of a liquid crystal display element in accordance with an embodiment of the present invention. (a) of FIG. 1 illustrates a state in which no pressing force is applied to the liquid crystal panel. (b) of FIG. 1 illustrates a state in which a pressing force is applied to the liquid crystal panel.

FIG. 2

FIG. 2 is a view of a general configuration of a liquid crystal display element in accordance with a comparative example. (a) of FIG. 2 illustrates a state in which no pressing force is applied to the liquid crystal panel. (b) of FIG. 2 illustrates a state in which a pressing force is applied to the liquid crystal panel.

FIG. 3

FIG. 3 is a view showing a relation between an applied voltage and transmittance. (a) of FIG. 3 corresponds to the liquid crystal display element of the present embodiment. (b) of FIG. 3 corresponds to the liquid crystal display element of the comparative example.

FIG. 4

FIG. 4 is a view showing a relation between a groove depth and transmittance.

FIG. 5

FIG. 5 is a cross-sectional view of the liquid crystal display element of the present embodiment and shows equipotential lines and orientations of liquid crystal molecules.

FIG. 6

FIG. 6 is a cross-sectional view of the liquid crystal display element of the present embodiment and shows equipotential lines and orientations of liquid crystal molecules. (a) of FIG. 6 shows a state in which no pressing force is applied to the liquid crystal panel. (b) of FIG. 6 shows a state in which a pressing force is applied to the liquid crystal panel.

FIG. 7

FIG. 7 is a cross-sectional view of the liquid crystal display element of the comparative example and shows equipotential lines and orientations of liquid crystal molecules. (a) of FIG. 7 shows a state in which no pressing force is applied to the liquid crystal panel. (b) of FIG. 7 shows a state in which a pressing force is applied to the liquid crystal panel.

FIG. 8

FIG. 8 is a view of a general configuration of a liquid crystal display element in accordance with a second embodiment. (a) of FIG. 8 illustrates a state in which no pressing force is applied to the liquid crystal panel. (b) of FIG. 8 illustrates a state in which a pressing force is applied to the liquid crystal panel.

FIG. 9

FIG. 9 is a view showing a relation between an applied voltage and transmittance. (a) of FIG. 9 corresponds to the liquid crystal display element of the second embodiment. (b) of FIG. 9 corresponds to the liquid crystal display element of the comparative example.

FIG. 10

FIG. 10 is a view showing a relation between a groove depth and transmittance.

FIG. 11

FIG. 11 is a view of a general configuration of a liquid crystal display element in accordance with another embodiment of the present invention and illustrates a state in which no pressing force is applied to the liquid crystal panel.

FIG. 12

FIG. 12 is a view of a general configuration of a liquid crystal display element in accordance with yet another embodiment of the present invention and illustrates a state in which no pressing force is applied to the liquid crystal panel.

### DESCRIPTION OF EMBODIMENTS

The following description will discuss embodiments of the present invention in detail.

### Embodiment 1

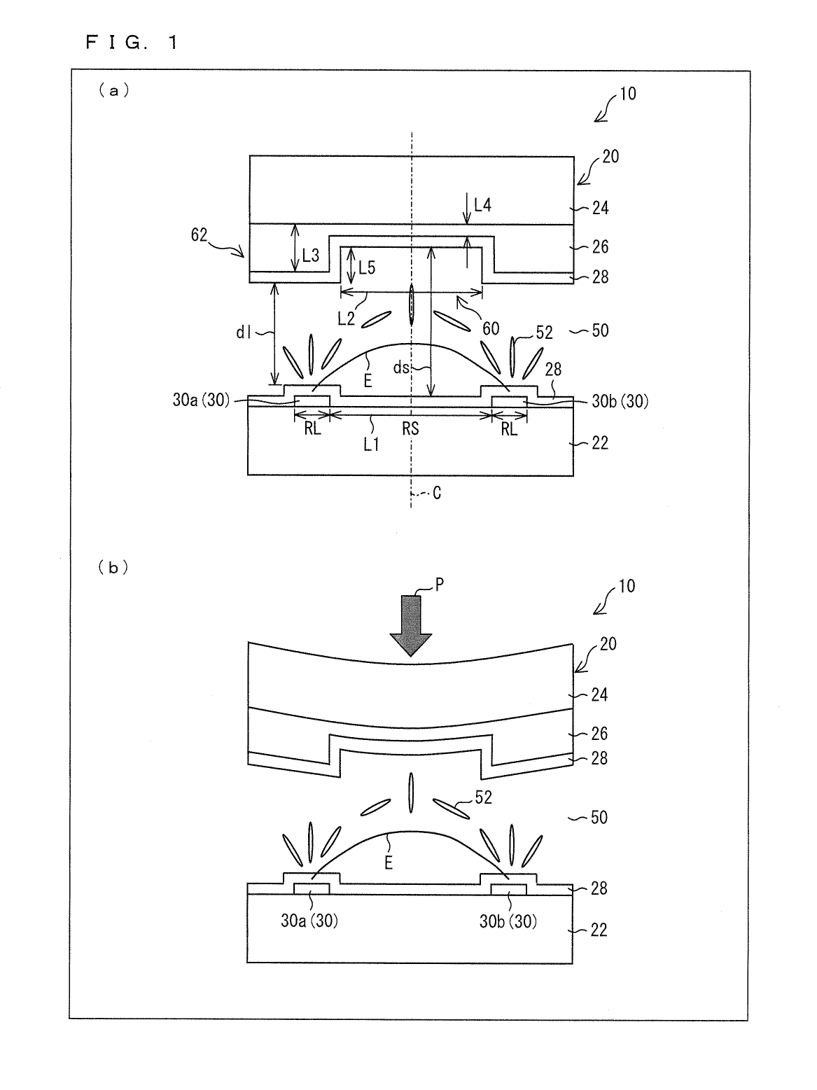

One embodiment of the present invention will be described below with reference to FIGS. 1 through 7, etc.

(a) of FIG. 1 is a cross-sectional view schematically illustrating a liquid crystal display element 10 in accordance with an embodiment of the present invention. (a) of FIG. 1 illustrates a state in which no pressing force is applied to the liquid crystal panel 20.

The liquid crystal display element 10 of the present embodiment is used as a display section in a liquid crystal display device such as a liquid crystal TV. The liquid crystal display element 10 is configured to employ a display mode in which liquid crystal molecules 52 are vertically aligned and driven by means of a transverse electric field (may hereinafter be referred to as a vertical-alignment transverse-electric-field mode). Note that the transverse electric field denotes an electric field which is generated (i) by means of a potential difference generated on a single substrate instead of a potential difference between two substrates facing each other and (ii) mainly in a direction parallel to the single substrate.

First, a description will be given on a general configuration of the liquid crystal display element 10 of the present embodiment, with reference to (a) of FIG. 1.

As illustrated in FIG. 1, the liquid crystal panel 20 in the liquid crystal display element 10 of a vertical-alignment transverse-electric-field mode has a configuration in which a liquid crystal layer 50 containing liquid crystal molecules 52 is sandwiched between an array substrate 22 and a counter substrate 24, which are two substrates facing each other.

The array substrate 22 is provided with interleaved electrodes 30. (a) of FIG. 1 illustrates an area in which two interleaved electrodes 30 (a first interleaved electrode 30a and a second interleaved electrode 30b) are provided adjacent to each other.

In the liquid crystal display element 10, a plurality of pixels are arranged in matrix. Note that the number of the interleaved electrodes 30 provided to each of the pixels is not limited to a specific one and can be determined appropriately in accordance with, for example, a pitch between the plurality of pixels, a width of an electrode, a width of a space between electrodes, or the like.

Displaying is carried out by applying a potential difference between the first interleaved electrode 30a and the second interleaved electrode 30b. The potential difference causes an electric field (equipotential lines E) to be generated between the first interleaved electrode 30a and the second interleaved electrode 30b. This causes orientations of the liquid crystal molecules 52 to be changed. The change in orientations causes a change in transmittance.

That is, one of the interleaved electrodes 30 adjacent to each other is a common electrode, to which a voltage of 0 V is mainly applied. The other one of the interleaved electrodes 30 is a drain electrode, which is connected with a signal line and a switching element and to which a signal is applied in accordance with a video signal.

Since the liquid crystal display element 10 employs the vertical-alignment transverse-electric-field mode, the liquid crystal molecules 52 in the liquid crystal display element 10 are oriented vertical to the two substrates in a case where the electric field is not generated, that is, in a case where the liquid crystal display element 10 has been turned off (voltage is OFF).

Then, when the liquid crystal display element 10 is turned on (voltage is ON) and the electric field is generated, orientations (directors) of the liquid crystal molecules 52, which have been vertically aligned, change to orient along the electric field (the equipotential lines E), which is generated in a lateral direction.

(a) of FIG. 1 illustrates a state in which the liquid crystal display element 10 is turned on (voltage is ON). In the state where the voltage is ON, liquid crystal molecules 52 in electrode areas RL and a liquid crystal molecule 52 on a center line (an inter-electrode area center line C) in an inter-electrode area RS are vertically aligned, whereas liquid crystal molecules 52 in other areas are oriented (i) substantially parallel to the two substrates and (ii) along the transverse electric field, which has been generated.

That is, in a case where the voltage is applied to the interleaved electrode 30 which is one of the interleaved electrodes 30 and serves as the drain electrode, the transverse electric field, which is an electric field substantially parallel to the two substrates, is generated. This tilts the liquid crystal molecules 52. At this time, the orientations of the liquid crystal molecules 52 are symmetrical between the interleaved electrodes 30 which are adjacent to each other and over which the transverse electric field is generated.

The change in orientations of the liquid crystal molecules 52 causes a change in amount of transmitted light. This allows the liquid crystal display device to function as a display device.

The description above corresponds to a case in which, the liquid crystal molecules 52 have a positive dielectric anisotropy (i.e., a positive liquid crystal material (Δε takes a positive value)). Note, however, the liquid crystal molecules 52 used in the liquid crystal display element 10 of the present embodiment are not limited to ones having a positive dielectric anisotropy dielectric anisotropy but can be ones having a negative dielectric anisotropy dielectric anisotropy (i.e., negative liquid crystals (Δε takes a negative value)).

### Dielectric Layer

In the liquid crystal display element 10 of the present embodiment, the dielectric layer 26 is provided to the counter substrate 24. The thickness of the dielectric layer 26 varies at different positions on the counter substrate 24.

That is, the dielectric layer 26 has different thicknesses in (i) the inter-electrode area RS, which is an area between the first interleaved electrode 30a and the second interleaved electrode 30b (which are the interleaved electrodes 30 adjacent to each other) and in the electrode areas RL, which are areas in which the interleaved electrodes 30 are provided.

Specifically, a thickness L3 of the dielectric layer 26 in the electrode areas RL is larger than a thickness L4 of the dielectric layer 26 in the inter-electrode area RS.

This is because the dielectric layer 26 is configured to have a U-like shaped groove in a portion corresponding to the inter-electrode area RS. That is, the thickness L3 of the dielectric layer 26 in the electrode areas RL is a thickness of the dielectric layer 26 in its original state where the groove in the U-like shape had not been provided, and the thickness L4 of the dielectric layer 26 in the inter-electrode area RS is a remaining thickness of the dielectric layer 26 in the groove in the U-like shape.

In the dielectric layer 26, the portions with a large thickness in the electrode areas RL are dielectric layer protruding portions 62 (which serve as projections) while, portions with a small thickness in the inter-electrode areas RS, are dielectric layer recessed portions 60.

Since the dielectric layer protruding portions 62 and the dielectric layer recessed portions 60 are provided in the liquid crystal display element 10 of the present embodiment, a thickness dl of the liquid crystal layer in the electrode areas RL is smaller than a liquid crystal layer thickness ds in the inter-electrode areas RS.

### Groove Width

Note that the groove having the U-like shape in the dielectric layer 26 is not particularly limited in terms of shapes, such as a cross-sectional shape, thereof in the dielectric layer 26, sizes, such as a depth L5 of the groove and a width L2 of the groove, and the like.

(a) of FIG. 1 illustrates an exemplary configuration in which the groove has a rectangular cross-section and a length L1 of the inter-electrode area RS is equal to the width L2 of the groove. The width L2 of the groove is preferably equal to the length L1 of the inter-electrode area RS between the interleaved electrodes.

In a case where the width L2 of the groove is smaller than the length L1 of the inter-electrode area RS, a display unevenness prevention effect may be reduced, which effect is exhibited when the liquid crystal panel 20 is pressed.

In a case where the width L2 of the groove is set smaller than the length L1 of the inter-electrode area RS, it is preferable that a center of the width L2 of the groove match a center (an inter-electrode area center line C) of the inter-electrode area RS along a lateral direction.

By setting at least the inter-electrode area center line C to be included within the width L2 of the groove, it is possible to attain more reliably the display unevenness prevention effect. That is, in a case where the dielectric layer recessed portion 60 has a width smaller than a distance between the interleaved electrodes (i.e., the length L1), the dielectric layer recessed portion 60 is preferably provided at a location that allows the dielectric layer recessed portion 60 to cover at least the inter-electrode area center line C. This is preferred for the following reason. That is, in the liquid crystal display element 10 of the vertical-alignment transverse-electric-field mode, when a voltage is ON, that is, when a voltage is applied to the liquid crystal molecules 52, a dark line with a width varying in accordance with the voltage thus applied is generated at a location between the interleaved electrodes 30 adjacent to each other. In a case where (i) the dielectric layer recessed portion 60 covers the location where the dark line is generated and the width L2 of the groove of the dielectric layer recessed portion 60 is larger than the width of the dark line, the display unevenness prevention effect is enhanced.

Also in a case where the width L2 of the groove is larger than the length L1 of the inter-electrode area RS, it is possible to attain the display unevenness prevention effect. However, in the case where the width L2 of the groove is larger than the length L1 of the inter-electrode area RS, an average d·Δn (d is a liquid crystal layer thickness and Δn is a reflective index difference of a liquid crystal material) changes, as in the configuration in which the cell thickness is increased. This may cause a change in optical characteristic and resultant degradation in a display performance.

### Dielectric Material

As for the dielectric layer 26, the following configuration can be employed in a case where the counter substrate 24 is provided with a color filter.

In the configuration, the dielectric layer 26 is provided between the liquid crystal layer 50 and the counter substrate 24, which is the substrate provided with the color filter out of the two substrates. The dielectric layer 26 is provided above a color filter layer which includes a black matrix layer, and therefore further functions to (i) improve flatness of the color filter layer and the like and (ii) prevent a material of the color filter from dissolving into the liquid crystal layer 50.

The dielectric layer 26 is processed so as to form the groove, having the U-like shape, in the dielectric layer 26. Thus, the dielectric layer recessed portion 60 and the dielectric layer protruding portions 62 are provided.

Note that the material of the dielectric layer 26 is not limited to a specific one. The dielectric layer 26 can be made of an insulating material or the like, specifically, an organic material and an inorganic material, for example.

For the organic material, a photosensitive acrylic resin can be employed, for example.

For the inorganic material, SiNx, SiOx or the like can be used by forming a film of SiNx, SiOx or the like with a desired film thickness and patterning the film.

### Alignment Film

An alignment film 28 is provided on each of a surface of the array substrate 22 and a surface of the counter substrate 24, both of which surfaces face the liquid crystal layer 50. The alignment films are not limited to a specific type and can employ an organic material or an inorganic material, for example. Since the liquid crystal display element 10 of the present embodiment is configured to employ the vertical-alignment transverse-electric-field mode, vertical alignment films are used as the alignment films 28.

A film thickness of the alignment film 28 at portions on the interleaved electrodes 30 does not have to be equal to a film thickness of the alignment film 28 at a non-electrode portion. In other words, a film thickness of the alignment film 28 in the electrode areas RL does not have to be equal to a film thickness of the alignment film 28 in the inter-electrode area RS. In a case where the interleaved electrodes 30 are nontransparent electrodes made of a nontransparent material, a configuration can be employed in which the alignment film 28 is not provided at portions on the interleaved electrodes 30 and portions facing the interleaved electrodes 30.

### Liquid Crystal Layer Thickness

As described above, the dielectric layer recessed portion 60 is provided in the dielectric layer 26 in the liquid crystal display element 10 of the present embodiment. This makes a difference between the liquid crystal layer thickness (cell gap) dl in the electrode areas and the liquid crystal layer thickness (cell gap) ds in the inter-electrode area.

Specifically, the liquid crystal layer thickness (cell gap) ds in the inter-electrode area is larger than the liquid crystal layer thickness (cell gap) dl in the electrode areas.

In addition to the dielectric layer 26 provided on the counter substrate 24, the interleaved electrodes 30 are further provided on the array substrate 22 and the alignment films 28 are further provided on the array substrate 22 and the counter substrate 24. Nevertheless, the depth (groove depth) L5 of the dielectric layer recessed portion 60 is sufficiently larger than the thickness of the interleaved electrodes 30 and the alignment films 28 and therefore allows a difference to be made between the liquid crystal layer thickness dl in the electrode areas and the liquid crystal layer thickness ds in the inter-electrode area by forming the groove present in the inter-electrode area but absent in the electrode areas. Note that, for easy explanation, FIG. 1 shows the interleaved electrodes 30 and the alignment films 28 thicker than real size.

### Comparative Example

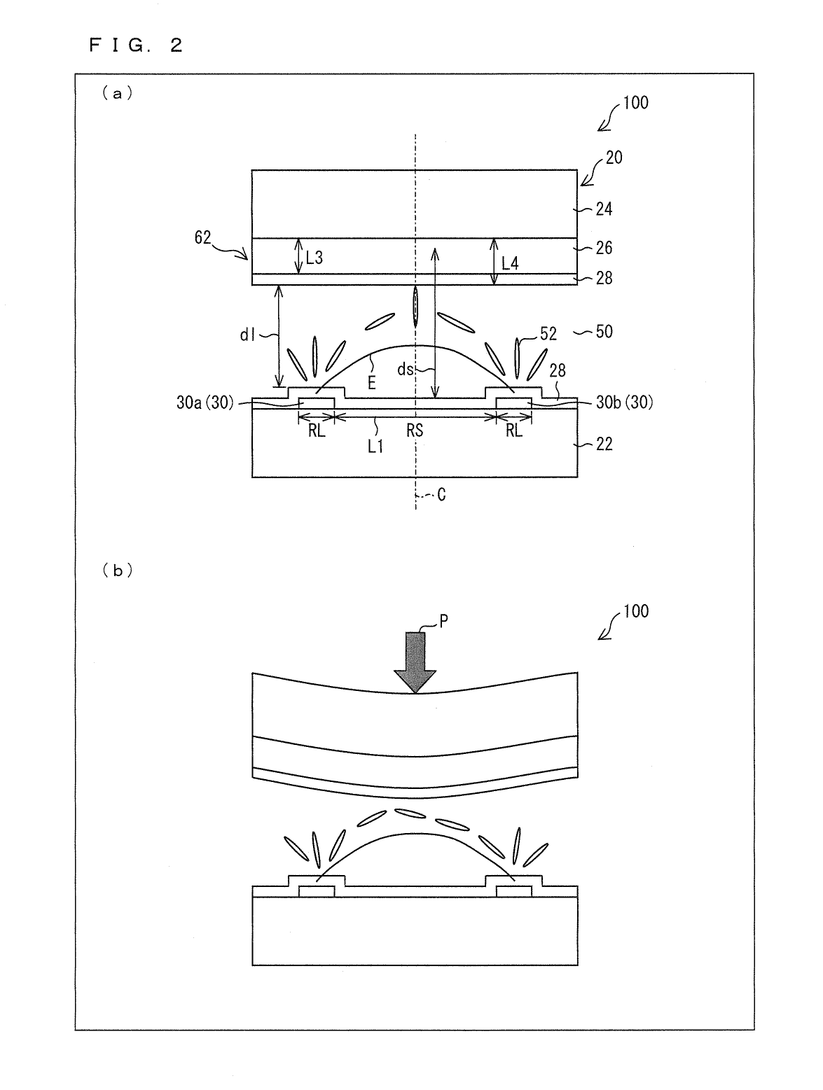

Next, the following description will discuss, with reference to (a) of FIG. 2, a general configuration of the liquid crystal display element 100 of a comparative example. (a) of FIG. 2 is a cross-sectional view of a general configuration of the liquid crystal display element 100 of the comparative example.

The liquid crystal display element 100 of the comparative example is different from the liquid crystal display element 10 of Embodiment 1 in that no groove is provided in the dielectric layer 26.

That is, although the liquid crystal display element 100 of the comparative example is the same as the liquid crystal display element 10 of Embodiment 1 in that the counter substrate 24 is provided with the dielectric layer 26, the dielectric layer recessed portion 60 which serves as the groove is not provided. The dielectric layer 26 has the same thickness in the electrode areas RL and the inter-electrode area RS.

Since the dielectric layer 26 has a uniform thickness, the liquid crystal layer thickness dl in the electrode areas is equal to the liquid crystal layer thickness ds in the inter-electrode area.

As early described, FIG. 2 illustrates the liquid crystal display element 100 of the comparative example as if the liquid crystal layer thickness dl in the electrode areas and the liquid crystal layer thickness ds in the inter-electrode area are different due to the groove present in the inter-electrode area but absent in the electrode areas. In reality, however, the interleaved electrodes 30 have a thickness sufficiently smaller than that of the liquid crystal layer 50, so that the liquid crystal layer thickness dl in the electrode areas is substantially equal to the liquid crystal layer thickness ds in the inter-electrode area in the liquid crystal display element 100 of the comparative example.

### With Pressing Force

Next, the following description will discuss, with reference to (b) of FIG. 1 and (b) of FIG. 2, a state in which a pressing force P is applied to the liquid crystal panel 20. (b) of FIG. 1 is a view of a general configuration of the liquid crystal display element 10 of the present embodiment and illustrates a state in which a pressing force is applied to the liquid crystal panel 20. (b) of FIG. 2 is a view of a general configuration of the liquid crystal display element 100 of the comparative example and illustrates a state in which a pressing force is applied to the liquid crystal panel 20. (b) of FIG. 1 and (b) of FIG. 2 each illustrates a state in which a voltage is ON.

In the liquid crystal display element 10 of the present embodiment, the dielectric layer recessed portion 60, which serves as the groove having the U-like shape, is provided in the dielectric layer 26. This renders the liquid crystal layer thickness ds in the inter-electrode area larger than the liquid crystal layer thickness dl in the electrode area. As such, even if the pressing force P is applied to the liquid crystal panel 20, the alignment of the liquid crystal molecules 52 is not easily affected by the pressing force P and display unevenness does not easily occur especially in the inter-electrode area RS.

That is, as illustrated in (b) of FIG. 2, in the liquid crystal display element 100 of the comparative example, in which the dielectric layer recessed portion 60 is not provided, the liquid crystal molecules 52, which are supposed to be vertically oriented, are oriented not vertically but substantially horizontally near the inter-electrode area center line C. Such irregularity in the orientations of the liquid crystal molecules 52 causes display unevenness to be easily generated in the liquid crystal display element 100 of the comparative example.

In comparison, as illustrated in (b) of FIG. 1, in the liquid crystal display element 10 of the present embodiment, in which the dielectric layer recessed portion 60 is provided, even if the pressing force P is applied to the liquid crystal panel 20, the orientations of the liquid crystal molecules 52 near the inter-electrode area center line C do not easily get irregular but are substantially vertical. That is, even if the pressing force P is applied, in the orientations of the liquid crystal molecules 52 in the inter-electrode area RS are not distorted.

In other words, the liquid crystal display element 10 of the present embodiment can prevent a phenomenon which tends to be produced in a case of a reduction in thickness of the liquid crystal layer 50 due to a hard pressing force P and in which (i) an orientation stabilizing effect of the bend orientation is reduced, (ii) the orientations of the liquid crystal molecules are accordingly distorted, and (iii) consequently, the liquid crystal molecules 52 are no longer in the bend orientation, in which the liquid crystal molecules are symmetrical oriented.

Therefore, in the liquid crystal display element 10 of the present embodiment, the pressing force P applied to the liquid crystal panel 20 hardly causes a difference in light transmission amount in the liquid crystal panel 20 between a portion where the pressing force P is applied and a portion where no pressing force P is applied. This prevents display unevenness. This will be described below in further detail.

### Groove Depth and Transmittance

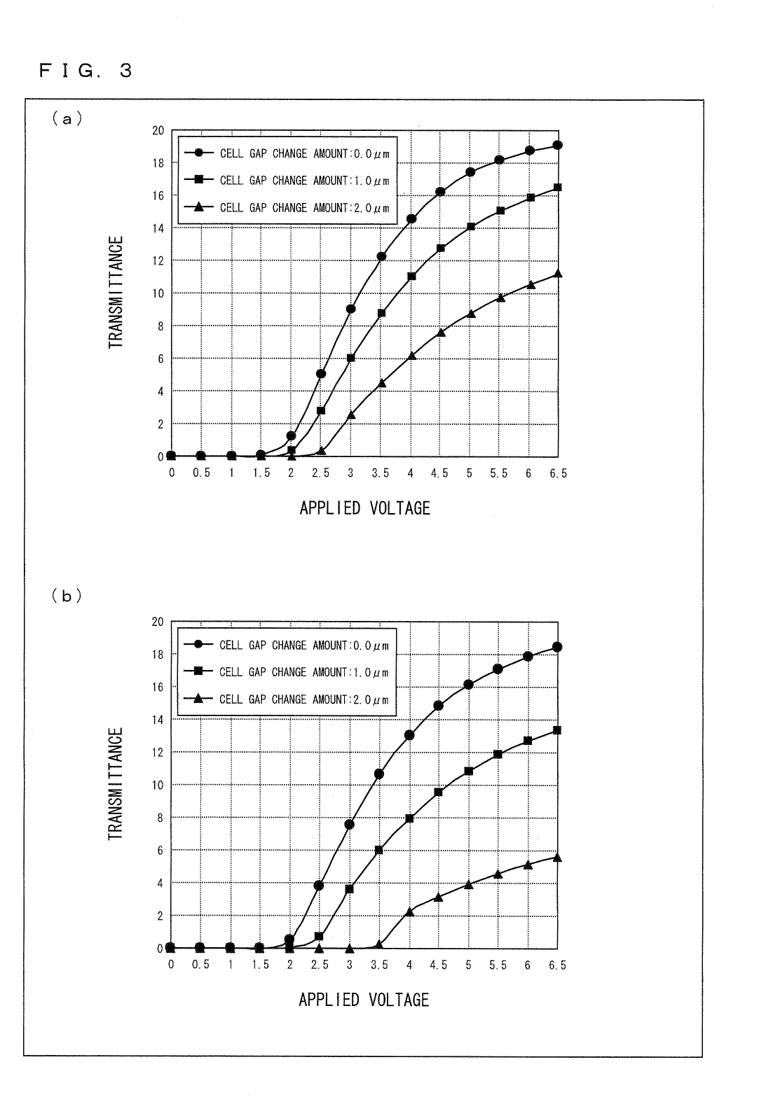

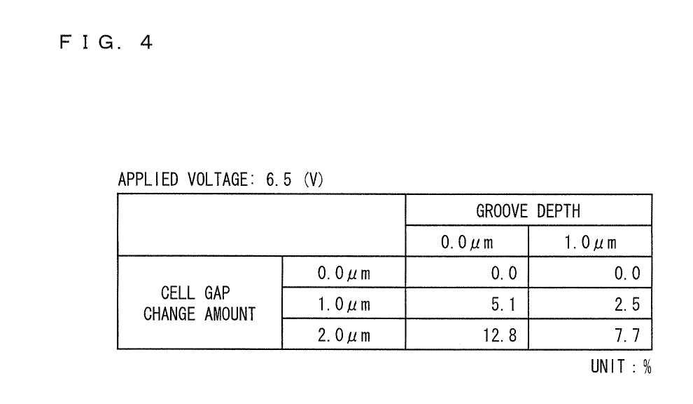

FIG. 3 is a view showing a relation between an applied voltage and transmittance with respect to various amounts of change in cell gap. (a) of FIG. 3 corresponds to the liquid crystal display element of the present embodiment. (b) of FIG. 3 corresponds to the liquid crystal display element of the comparative example. FIG. 4 is a view showing a relation between a groove depth and transmittance.

In the liquid crystal display element 10 of the present embodiment whose transmittance characteristic is shown in (a) of FIG. 3, the dielectric layer thickness L3 in the electrode areas is 3 μm, the groove depth L5 is 1 μm, and the dielectric layer thickness L4 in the inter-electrode area is 2 μm.

In the liquid crystal display element 100 of the comparative example whose characteristic is shown in (b) of FIG. 3, the dielectric layer thickness L3 in the electrode areas and the dielectric layer thickness L4 in the inter-electrode area are both 3 μm and the groove depth L5 is 0 μm, due to lack of the dielectric layer recessed portion 60.

In the liquid crystal display element 10 whose characteristic is shown in (a) of FIG. 3, an electrode width (L: line) of and an inter-electrode distance (S: space) of interleaved electrodes 30 are both 4 μm. The same is true of the liquid crystal display element 100 whose characteristic is shown in (b) of FIG. 3.

In each of (a) of FIG. 3 and (b) of FIG. 3, the filled circle sign corresponds to a case in which the amount of change in cell gap, which change is caused by the pressing force P, is 0.0 μm, the filled square sign corresponds to a case in which the amount of change in cell gap is 1.0 μm, and the filled triangle sign corresponds to a case in which the amount of change in cell gap is 2.0 μm.

As indicated by the filled square sign and the filled triangle sign in each of (a) of FIG. 3 and (b) of FIG. 3, a V-T characteristic significantly changes as the amount of change in cell gap changes to 1.0 μm, subsequently to 2.0 μm, in the liquid crystal display element 100 of the comparative example, whereas the liquid crystal display element 10 of the present embodiment has a reduced change in V-T characteristic.

That is, in the liquid crystal display element 100 of the comparative example, the transmittance significantly decreases as the amount of change in cell gap increases especially in a case where a high voltage is applied.

In comparison, the decrease in transmittance, which occurs especially in a case where a high voltage is applied and the amount of change in cell gap is large, is reduced in the liquid crystal display element 10 of the present embodiment.

FIG. 4 is a chart showing how the transmittance changes in accordance with the amount of change in cell gap when a voltage of 6.5 V is applied in a case where a groove is provided (i.e., the groove depth L5 is 1.0 μm) and in a case where no groove is provided (i.e., the groove depth L5 is 0.0 μm).

As shown in FIG. 4, in a case where the amount of change in cell gap changes from 0.0 μm to 2.0 μm, the transmittance changes by 12.8% in the liquid crystal display element 100 of the comparative example, in which the groove depth is 0.0 μm. In comparison, the change in transmittance is reduced to 7.7% in the liquid crystal display element 10 of the present embodiment, in which the groove with a depth of 1.0 μm is provided.

As described above, the liquid crystal display element 10 of the present embodiment has a small change in transmittance at the time of pressing force, as compared with the liquid crystal display element 100 of the comparative example.

### Insensitive Area

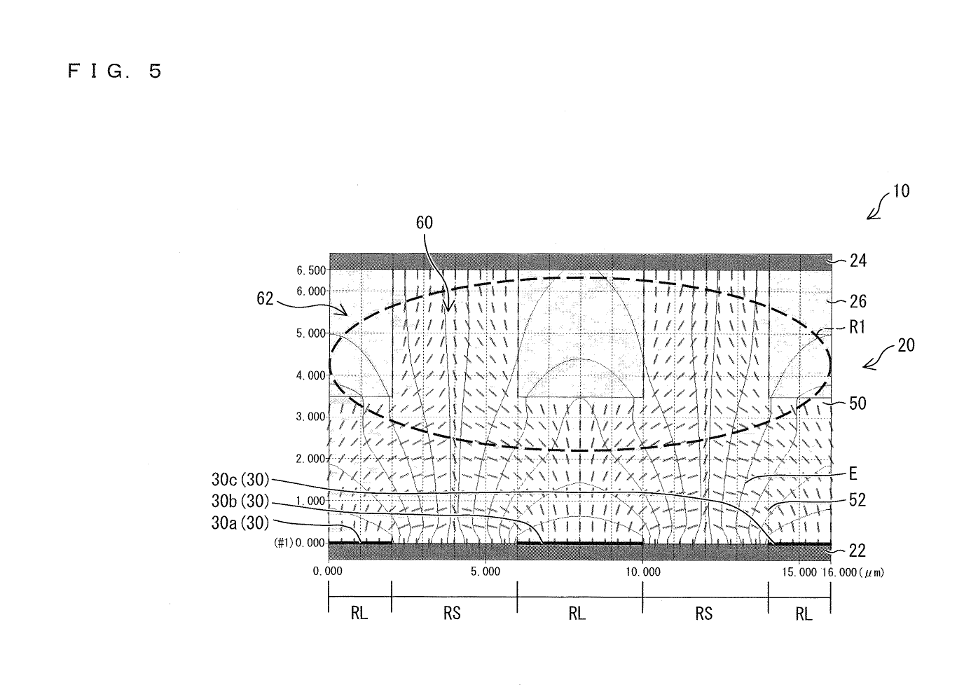

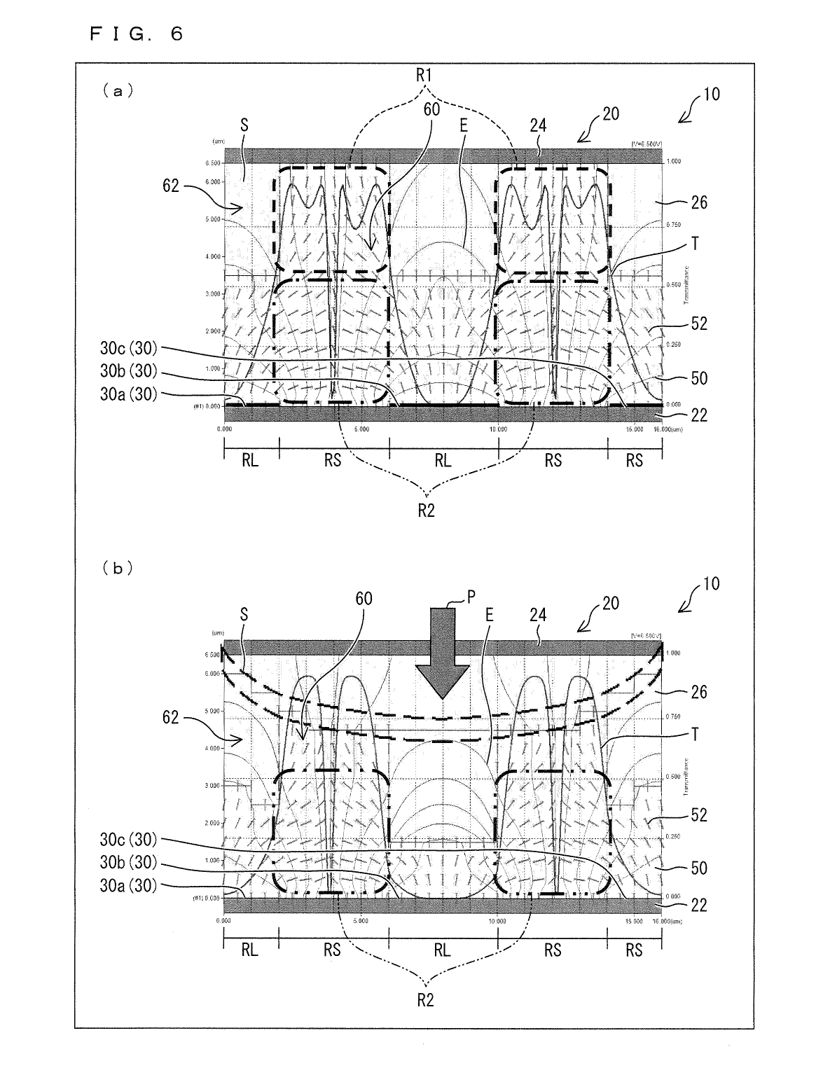

The following description will discuss presence or absence of the dielectric layer recessed portion 60 and the orientations of the liquid crystal molecules 52, with reference to FIGS. 5 through 7. To explain how the transmittance changes when a pressing force is applied, FIGS. 5 and 6 illustrate, as one example, the liquid crystal display element 10 in which the counter substrate 24 is provided with no dielectric layer 26 at a portion that corresponds to the inter-electrode area RS. That is, FIGS. 5 and 6 shows an exemplary configuration in which the dielectric layer thickness L4 in the inter-electrode area is 0 μm. Although the configuration is different from the configuration as illustrated in FIG. 1, etc., the way the transmittance changes when a pressing force is applied is the same as that in the configuration as illustrated in FIG. 1, etc. The configuration in which the dielectric layer thickness L4 in the inter-electrode area is 0 μm will be further discussed in description of Embodiment 2.

FIG. 5 is a cross-sectional view of the liquid crystal display element 10 of the present embodiment and shows equipotential lines and orientations of the liquid crystal molecules.

As shown in FIG. 5, the liquid crystal panel 20 has an insensitive area R1, in which the liquid crystal molecules 52 are not tilted to a great extent. The insensitive area R1 has an electric field of low intensity, so that the liquid crystal molecules 52 are not easily affected by the electric field. This is why the liquid crystal molecules 52 are not tilted as much as those in other portions. The insensitive area R1 exists closer to the counter substrate 24, which is a substrate that faces the array substrate 22, which is a substrate provided with the interleaved electrodes 30.

### Display Unevenness in Present Embodiment

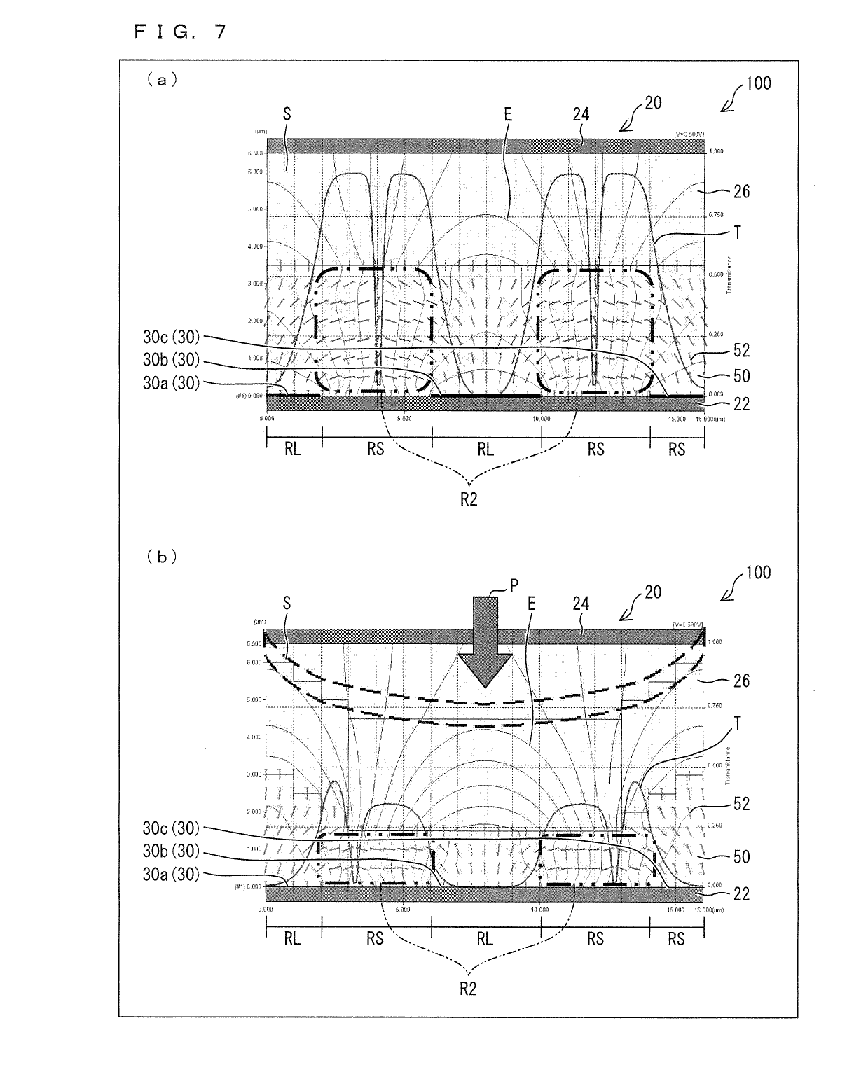

Next, the following description will discuss, with reference to FIGS. 6 and 7, a relation between the insensitive area R1 and prevention of display unevenness.

FIG. 6 is a schematic cross-sectional view of the liquid crystal display element 10 of the present embodiment and shows equipotential lines E and orientations of the liquid crystal molecules 52. (a) of FIG. 6 shows a state in which the pressing force P is not applied to the liquid crystal panel 20. (b) of FIG. 6 shows a state in which the pressing force P is applied to the liquid crystal panel 20.

FIG. 7 is a schematic cross-sectional view of the liquid crystal display element 100 of the comparative example and shows equipotential lines E and orientations of the liquid crystal molecules 52. (a) of FIG. 7 shows a state in which the pressing force P is not applied to the liquid crystal panel 20. (b) of FIG. 7 shows a state in which the pressing force P is applied to the liquid crystal panel 20.

As shown in (a) of FIG. 6, in the liquid crystal display element 10 in which the groove is provided in the dielectric layer 26 so as to form the dielectric layer recessed portion 60, the dielectric layer recessed portion 60 serves as the insensitive area R1, which has been early described.

A portion which is in the inter-electrode area RS and near the array substrate 22, which portion is an area below the insensitive area R1, serves as an area that contributes to transmittance (hereinafter referred to as a transmittance area R2). The transmittance area R2 is a portion in which a maximum transmittance is obtained when the voltage is ON. The transmittance area R2 has an optimum Δnd.

As shown in (a) of FIG. 6, in a case where the dielectric layer recessed portion 60 is provided, (i) the dielectric layer recessed portion 60 serves as the insensitive area R1 and a cell gap d (the liquid crystal layer thickness) is increased in terms of structure. However, since the liquid crystal molecules 52 are barely tilted in the insensitive area R1 as described above, Δn in the insensitive area R1 becomes very small. Thus, it becomes possible to maintain Δnd in the portion having the insensitive area R1 to a substantially same level as the optimum Δnd in the configuration in which the dielectric layer recessed portion 60 is not provided.

When the pressing force P is applied to the liquid crystal panel 20, the equipotential lines E and the orientations of the liquid crystal molecules 52 are as shown in (b) of FIG. 6.

As shown in (b) of FIG. 6, when the pressing force P is applied to the liquid crystal panel 20, the substrate to which the pressing force P is applied is deformed (broken lines S in (b) of FIG. 6). Some of the liquid crystal molecules 52 in the insensitive area R1 are tilted due to deformation S of the substrate caused by the pressing force P. As such, even if the pressing force P causes deformation, it is possible to maintain the optimum Δnd and therefore compensate for the transmittance.

### Display Unevenness in Comparative Example

Unlike the liquid crystal display element 10 of the present embodiment, the liquid crystal display element 100 of the comparative example does not have the insensitive area R1, as shown in (a) of FIG. 7.

As such, as shown in (b) of FIG. 7, in a case where the pressing force P is applied to the liquid crystal panel 20 and the pressing force causes deformation S of the substrate, the cell gap d becomes small due to the deformation S. The cell gap d thus reduced does not allow Δnd to be an optimum value any more, and the transmittance is decreased accordingly. This causes display unevenness.

### Embodiment 2

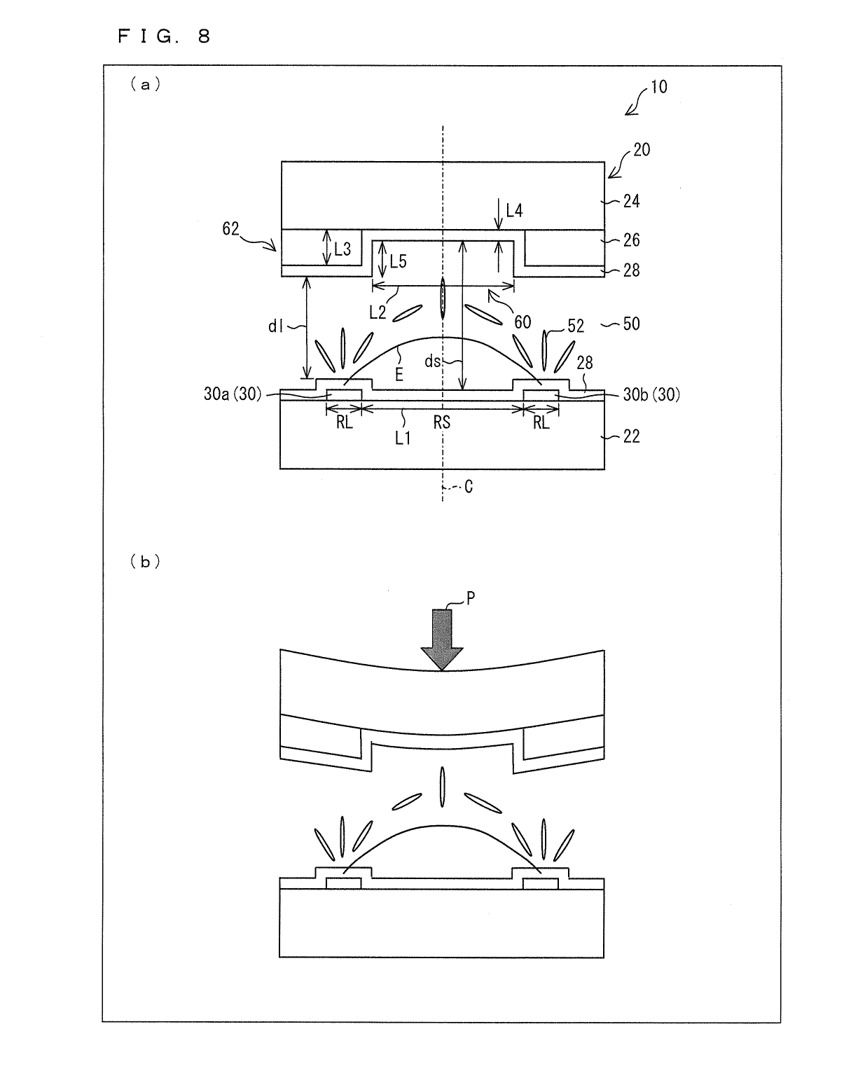

Next, the following description will discuss another embodiment of the liquid crystal display element 10 of the present invention, with reference to FIG. 8, etc.

For easy explanation, the like reference signs will be given to members each having the like function as a member as illustrated in the figures of Embodiment 1, and descriptions on such a member will be omitted.

Each of (a) of FIG. 8 and (b) of FIG. 8 is a view of a general configuration of the liquid crystal display element 10 of the present embodiment. (a) of FIG. 8 illustrates a state in which no pressing force is applied to the liquid crystal panel 20. (b) of FIG. 8 illustrates a state in which a pressing force is applied to the liquid crystal panel 20.

The liquid crystal display element 10 of the present embodiment is different from the liquid crystal display element 10 of Embodiment 1 in that the dielectric layer 26 is not provided on a portion, of the counter substrate 24, which corresponds to the inter-electrode area RS.

That is, as illustrated in (a) of FIG. 1, the dielectric layer thickness L4 in the inter-electrode area was 2 μm in the liquid crystal display element 10 of Embodiment 1. In comparison, the dielectric layer thickness L4 in the inter-electrode area is 0 μm in the liquid crystal display element 10 of the present embodiment, as illustrated in (a) of FIG. 8. The dielectric layer protruding portions 62, which serve as protruding portions, are provided in the electrode areas RL. The dielectric layer protruding portions 62 have a thickness of 3 μm, which thickness is the dielectric layer thickness L3 in the electrode areas.

As illustrated in (b) of FIG. 8, in the liquid crystal display element 10 of the present embodiment, even if the pressing force P is applied to the liquid crystal panel 20, the orientations of the liquid crystal molecules 52 near the inter-electrode area center line C hardly get irregular, and stay substantially vertical. That is, even if the pressing force P is applied, the orientations of the liquid crystal molecules 52 in the inter-electrode area RS are not distorted and the symmetry in the orientation is maintained.

Therefore, like the liquid crystal display element 10 of Embodiment 1, the pressing force P applied to the liquid crystal panel 20 in the liquid crystal display element 10 of the present embodiment hardly causes a difference in light transmission amount of the liquid crystal panel 20 between a portion to which the pressing force P has been applied and a portion to which no pressing force P has been applied. This prevents display unevenness.

### Groove Depth and Transmittance

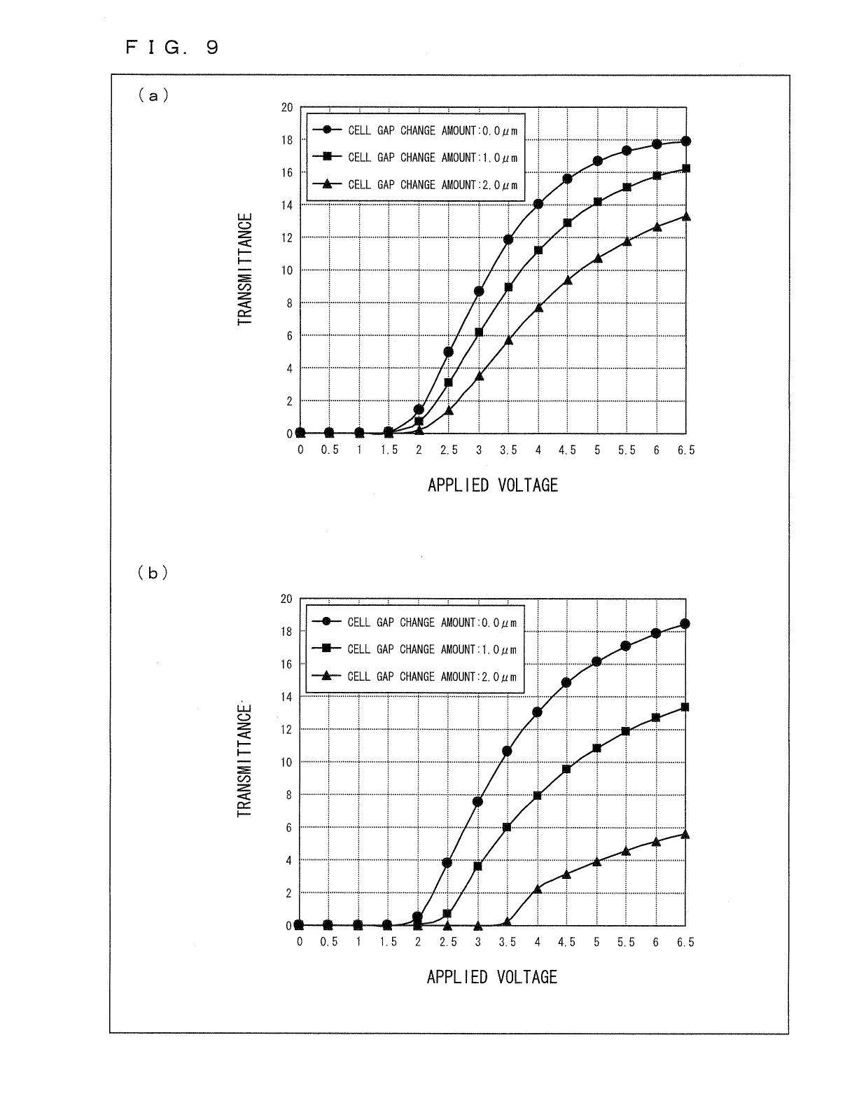

Next, a relation between a groove depth and transmittance will be described. FIG. 9, like FIG. 3, is a view showing a relation between an applied voltage and transmittance with respect to various amounts of change in cell gap. (a) of FIG. 9 corresponds to the liquid crystal display element of the present embodiment. (b) of FIG. 9 corresponds to the liquid crystal display element of the comparative example. (b) of FIG. 9 and (b) of FIG. 3 are identical.

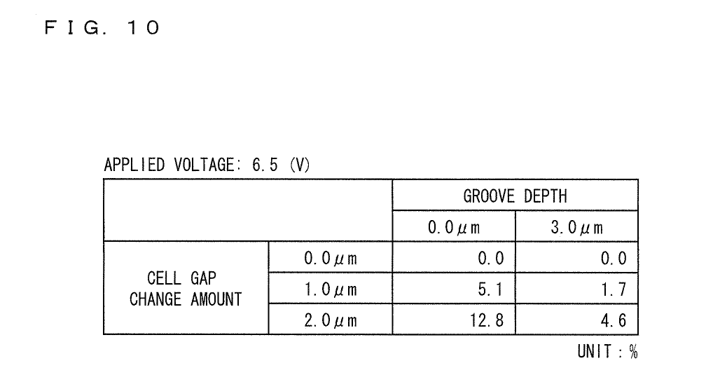

FIG. 10, like FIG. 4, is a view showing a relation between a groove depth and transmittance.

In the liquid crystal display element 10 of the present embodiment, whose transmittance characteristic is shown in (a) of FIG. 9, the dielectric layer thickness L3 in the electrode areas is 3 μm and the groove depth L5 is 3 μm. That is, the dielectric layer thickness L4 in the inter-electrode area is 0 μm.

In the liquid crystal display element 100 of the comparative example, whose characteristic is shown in (b) of FIG. 9, the dielectric layer thickness L3 in the electrode area and the dielectric layer thickness L4 in the inter-electrode area are both 3 μm and the groove depth L5 is 0 μm, due to lack of the dielectric layer recessed portion 60. That is, the liquid crystal display element 100 of the comparative example is the same as the liquid crystal display element 100 as illustrated in (b) of FIG. 3 in this respect.

In the liquid crystal display element whose characteristic is shown in (a) of FIG. 9, an electrode width (L: line) of and an inter-electrode distance (S: space) of interleaved electrodes 30 are both 4 μm. The same is true of the liquid crystal display element whose characteristic is shown in (b) of FIG. 9.

In each of (a) of FIG. 9 and (b) of FIG. 9, the filled circle sign corresponds to a case in which the amount of change in cell gap due to the pressing force P is 0.0 μm, the filled square sign corresponds to a case in which the amount of change in cell gap is 1.0 μm, and the filled triangle sign corresponds to a case in which the amount of change in cell gap is 2.0 μm.

As indicated by the filled square sign and the filled triangle sign in each of (a) of FIG. 9 and (b) of FIG. 9, the V-T characteristic significantly changes as the amount of change in cell gap changes to 1.0 μm, subsequently to 2.0 μm, in the liquid crystal display element 100 of the comparative example, whereas the liquid crystal display element 10 of the present embodiment, like the liquid crystal display element 10 of Embodiment 1, has a reduced change in V-T characteristic. As evidenced by the filled triangle signs that correspond to the case where the amount of change in cell gap is 2.0 μm, the liquid crystal display element 10 of the present embodiment has a reduced change in transmittance when a pressing force is applied, as compared with the liquid crystal display element 10 of Embodiment 1.

This will be discussed more concretely in the following description, with reference to FIG. 10.

FIG. 10 is a chart showing how the transmittance changes in accordance with the amount of change in cell gap when a voltage of 6.5 V is applied in a case where a groove is provided (i.e., the groove depth L5 is 3.0 μm) and in a case where no groove is provided (i.e., the groove depth L5 is 0.0 μm).

As shown in FIG. 10, in a case where the amount of change in cell gap changes from 0.0 μm to 2.0 μm, the transmittance changes by 12.8% in the liquid crystal display element 100 of the comparative example, in which the groove depth is 0.0 μm. In comparison, the change in transmittance is reduced to 4.6% in the liquid crystal display element 10 of the present embodiment, in which the groove with a depth of 3.0 μm is provided. The 4.6% change in transmittance is smaller than the 7.7% change in transmittance in the liquid crystal display element 10 of Embodiment 1. That is, especially in a case in which the amount of change in cell gap is large, the liquid crystal display element 10 of the present embodiment has a small change in transmittance, as compared with the liquid crystal display element 10 of Embodiment 1, let alone than the liquid crystal display element 100 of the comparative example.

### Embodiment 3

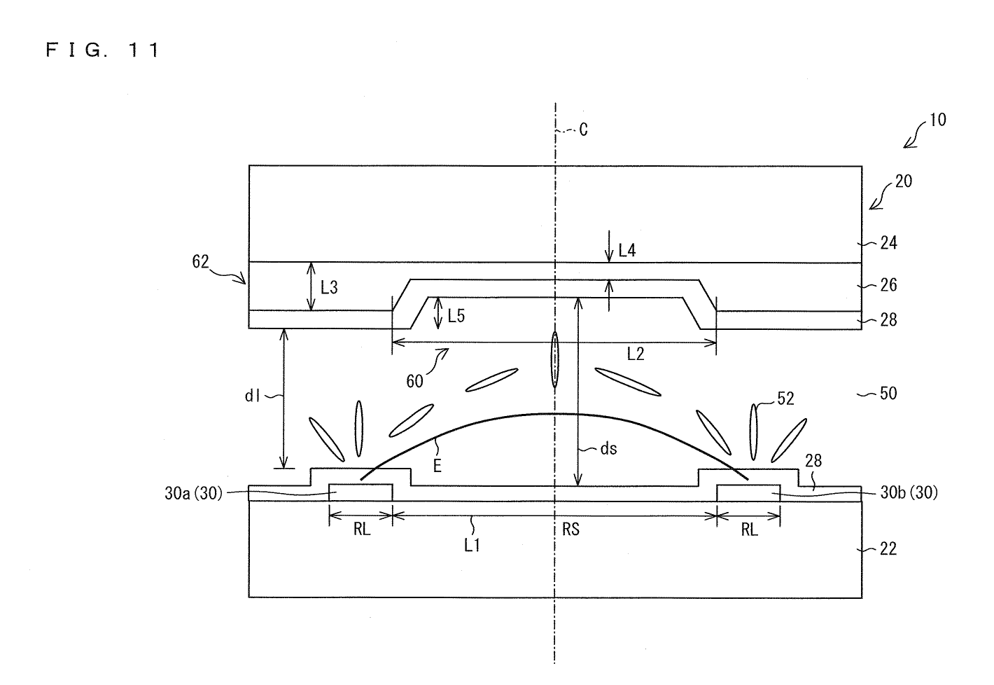

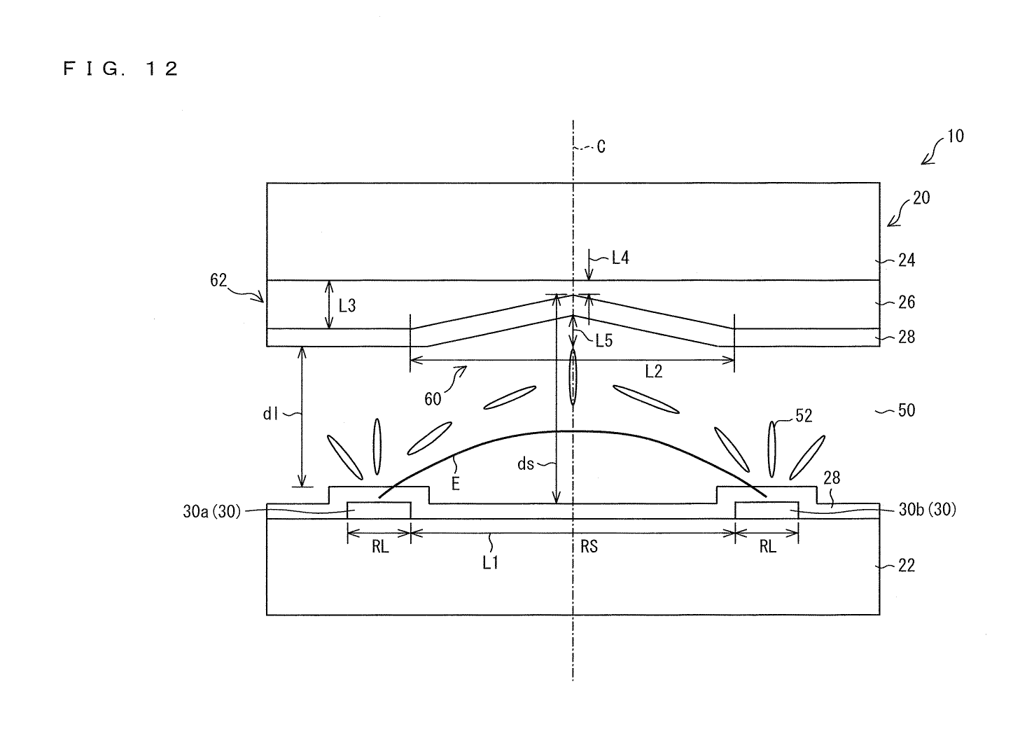

Next, the following description will discuss, with reference to FIGS. 11 and 12, yet another embodiment of the liquid crystal display element 10 of the present invention.

For easy explanation, the like reference signs will be given to a member having the like function as a member described in the early-described embodiments, and descriptions on such member will be omitted.

In the liquid crystal display element 10 of the present embodiment, the dielectric layer recessed portion 60, which serves as the groove in the U-like shape, has a different shape from those of the dielectric layer recessed portions 60 in the liquid crystal display elements 10 of the respective embodiments described above. That is, all of the dielectric layer recessed portions 60 in the liquid crystal display elements 10 of the respective early-described embodiments had a rectangular shape.

Note that the shape (cross-sectional shape) of the dielectric layer recessed portion 60 can be, for example, square such as rectangle, regular square, trapezoid, and other shapes such as semicircle, semiellipse, triangle, and the like.

Examples of such shapes are illustrated in FIGS. 11 and 12. FIG. 11 illustrates a general configuration of the liquid crystal display element 10 in which the dielectric layer recessed portion 60 having a trapezoidal cross-section is provided.

FIG. 12 illustrates a general configuration of the liquid crystal display element 10 in which the dielectric layer recessed portion 60 having a triangular cross-section is provided.

The liquid crystal display element 10 which is illustrated in FIG. 11 and in which the dielectric layer recessed portion 60 having a trapezoidal cross-sectional shape is provided can attain (i) an increased response speed and an improved orientation stability, in addition to (ii) prevention of display unevenness which occurs when a pressing force is applied.

That is, in a case where (i) the cross-sectional shape of the dielectric layer recessed portion 60 is trapezoid or the like and (ii) side surfaces of the dielectric layer recessed portion 60 are tilted with respect to a direction perpendicular to the counter substrate 24 (i.e., side surfaces of each of the dielectric layer protruding portions 62 are cross-sectionally tapered), it is possible to attain effects such as of increase in response speed and improvement in orientation stability.

The increase in response speed is especially prominent in a rise. The liquid crystal molecules 52 in the vicinity of the side surfaces, which are cross-sectionally tapered, of the dielectric layer protruding portions 62 are likely to be oriented along the side surfaces. Accordingly, the liquid crystal molecules 52 are likely to have a uniform orientation. As such, the liquid crystal molecules 52 are likely to start moving at a same timing in the rise. This increases a response speed in the rise.

The improvement in orientation stability allows a dark line in the liquid crystal display element 10 to be less apt to become a curved line. That is, in the liquid crystal display element 10 of a vertical-alignment transverse-electric-field mode, a portion, such as the vicinity of the inter-electrode area center line C, where the liquid crystal molecules 52 remain vertically oriented even in a state where ‘a voltage is ON,’ is observed as a dark line. Note that in a case where, the side surfaces of each of the dielectric layer protruding portions 62 are cross-sectionally tapered, the liquid crystal molecules 52 are likely to move at a same timing in a rise. This improves orientation stability of the liquid crystal molecules 52 in the vicinity of the inter-electrode area center line C, which is a boundary across which the liquid crystal molecules 52 rising from different directions face each other. As a result, the dark line observed at the boundary is less apt to become a curved line but is likely to look like a straight line.

The present invention is not limited to the above-described embodiments but allows various modifications within the scope of the claims. Any embodiment derived from an appropriate combination of the technical means disclosed in the different embodiments will also be included in the technical scope of the present invention.

The liquid crystal display element of the present invention further includes projections each of which is made from a dielectric material and provided at a position which (i) is on a surface of a second substrate which surface faces the liquid crystal layer, and (ii) overlaps corresponding one of these interleaved electrodes on a first substrate when viewed from above, where either one of the substrates on which interleaved electrodes among the interleaved electrodes are formed is referred to as a first substrate for these interleaved electrodes and the other one of the substrates which faces the first substrate is referred to as a second substrate for these interleaved electrodes.

According to the configuration, each of the projections is provided at the position which is on the second substrate and overlaps corresponding one of these interleaved electrodes. This makes it possible to easily reduce a thickness of the liquid crystal layer at a portion where each of the interleaved electrodes is provided as compared with a thickness of the liquid crystal layer at a portion where none of the interleaved electrodes is provided.

The liquid crystal display element of the present invention further includes a dielectric layer provided on a surface of a second substrate which surface faces the liquid crystal layer, the dielectric layer having a larger thickness where the dielectric layer overlaps these interleaved electrodes on a first substrate when viewed from above, than where the dielectric layer does not overlap any of the interleaved electrodes when viewed from above, where either one of the substrates on which interleaved electrodes among the interleaved electrodes are formed is referred to as a first substrate for these interleaved electrodes and the other one of the substrates which faces the first substrate is referred to as a second substrate for these interleaved electrodes.

According to the configuration, the dielectric layer has a larger thickness where the dielectric layer overlaps these interleaved electrodes than where the dielectric layer does not overlap any of the interleaved electrodes when viewed from above.

As such, it is possible to easily reduce a thickness of the liquid crystal layer at a portion where each of the electrodes is provided as compared with a thickness of the liquid crystal layer at a portion where none of the interleaved electrodes is provided, by controlling the thickness of the dielectric layer.

It also becomes possible to set given values to the thickness of the liquid crystal layer at the portion where each of the interleaved electrodes is provided and to the thickness of the liquid crystal layer at the portion where none of the interleaved electrodes is provided.

In the liquid crystal display element of the present invention, the dielectric layer has a recessed portion which has a reduced thickness, as a result of which the dielectric layer has the larger thickness where the dielectric layer overlaps the interleaved electrodes when viewed from above, than where the dielectric layer does not overlap any of the interleaved electrodes when viewed from above, the recessed portion covering, when viewed from above, a center line between the interleaved electrodes adjacent to each other.

In the liquid crystal display element of the vertical-alignment transverse-electric-field mode, a dark line is generated in the vicinity of the center line between the interleaved electrodes in a case where a voltage is applied. In a case where the recessed portion is provided at a position that allows the recessed portion to cover the dark line, display unevenness caused by application of a pressing force to the liquid crystal display element is better prevented.

In the liquid crystal display element of the present invention, each of the projections has a tapered shape.

In the liquid crystal display element of the present invention, the recessed portion of the dielectric layer has side surfaces which are tilted with respect to a line perpendicular to the second substrate.

According to the configuration, (i) each of the projections, which are provided at positions corresponding to the respective interleaved electrodes, has a tapered shape and (ii) the side surfaces of the recessed portion are tilted.

This increases a response speed and improves orientation stability of the liquid crystal molecules.

That is, in the vicinity of the projections each having a tapered and in the vicinity of the side surfaces, which are tilted, of the recessed portion, the liquid crystal molecules are likely to be oriented along the projections and the side surfaces. Accordingly, the liquid crystal molecules are likely to have a uniform orientation. As such, in a case where, for example, a voltage is applied to the liquid crystal element so that a voltage is applied to the liquid crystal molecules, the liquid crystal molecules are likely to start moving at a same timing. This makes it easier to increase a response speed especially at in a rise.

Further, since the liquid crystal molecules are likely to start moving at a same timing as described above, the liquid crystal molecules are more likely to have a uniform orientation even after the liquid crystal molecules, which started moving in response to the application of the voltage, finishes moving. This improves orientation stability of the liquid crystal molecules after the liquid crystal molecules finishes moving.

Accordingly, a dark line, which tends to be generated in the vicinity of the center line between the interleaved electrodes, does not easily shift but becomes stable. This improves display quality.

Note that the tapered shape refers to a sloped shape and the projection refers to, for example, such a shape that a cross-section and a bore diameter of the projection gradually decrease from its base to its tip.

Since the recessed portion has sloped side surfaces, the recessed portion as a whole has such a shape that, for example, the recessed portion gradually becomes larger from its bottom to its top.

In the liquid crystal display element of the present invention, the recessed portion has a trapezoidal cross-section.

In the liquid crystal display element of the present invention, the recessed portion has a triangular cross-section.

The liquid crystal display element of the present invention further includes a color filter layer on said surface of the second substrate, the dielectric layer being provided above the color filter layer.

In the liquid crystal display element of the present invention, the dielectric material is at least one of photosensitive acrylic resin, SiNx, and SiOx.

A liquid crystal display device of the present invention includes the liquid crystal display element as a display section.

### INDUSTRIAL APPLICABILITY

In the liquid crystal display element of the present invention, display unevenness does not easily occur even if a pressing force is applied to a liquid crystal panel in the liquid crystal display element. Therefore, the liquid crystal display element of the present invention is suitably applicable to a touch panel or other use in which high quality display is required.

### REFERENCE SIGNS LIST

10: liquid crystal display element
22: array substrate (substrate)
24: counter substrate (substrate)
26: dielectric layer
30: interleaved electrode (electrode)
30a: first interleaved electrode (electrode)
30b: second interleaved electrode (electrode)
30c: third interleaved electrode (electrode)
50: liquid crystal layer
60: dielectric layer recessed portion (recessed portion)
62: dielectric layer protruding portion (projection)
C: inter-electrode area center line (center line between electrodes)
dl: liquid crystal layer thickness in electrode area (thickness of liquid crystal layer at a portion where electrode is provided)
ds: liquid crystal layer thickness in inter-electrode area (thickness of liquid crystal layer at a portion where no electrode is provided)
L3: dielectric layer thickness in electrode area (thickness of dielectric layer provided at a position overlapping electrode)
L4: dielectric layer thickness in inter-electrode area (thickness of dielectric layer provided at a position not overlapping electrode)
RL: electrode area (position overlapping electrode)
RS: inter-electrode area (position not overlapping electrode)

1. A liquid crystal display element, which is a vertical alignment type liquid crystal display element including a pair of substrates, and a liquid crystal layer sandwiched between the substrates and being configured to carry out display operation by controlling orientations of liquid crystal molecules in the liquid crystal layer by use of transverse electric fields, comprising:
interleaved electrodes on at least one of the substrates,
the liquid crystal layer having a thickness which is smaller at a portion where each of the interleaved electrodes is provided than at a portion where none of the interleaved electrodes is provided.

2. A liquid crystal display element as set forth in claim 1, further comprising projections each of which is made from a dielectric material and provided at a position which (i) is on a surface of a second substrate which surface faces the liquid crystal layer, and (ii) overlaps corresponding one of these interleaved electrodes on a first substrate when viewed from above, where either one of the substrates on which interleaved electrodes among the interleaved electrodes are formed is referred to as a first substrate for these interleaved electrodes and the other one of the substrates which faces the first substrate is referred to as a second substrate for these interleaved electrodes.

3. A liquid crystal display element as set forth in claim 1, further comprising a dielectric layer which is made from a dielectric material and provided on a surface of a second substrate which surface faces the liquid crystal layer,
the dielectric layer having a larger thickness where the dielectric layer overlaps these interleaved electrodes on a first substrate when viewed from above, than where the dielectric layer does not overlap any of the interleaved electrodes when viewed from above, where either one of the substrates on which interleaved electrodes among the interleaved electrodes are formed is referred to as a first substrate for these interleaved electrodes and the other one of the substrates which faces the first substrate is referred to as a second substrate for these interleaved electrodes.

4. The liquid crystal display element as set forth in claim 3, wherein the dielectric layer has a recessed portion which has a reduced thickness, as a result of which the dielectric layer has the larger thickness where the dielectric layer overlaps the interleaved electrodes when viewed from above, than where the dielectric layer does not overlap any of the interleaved electrodes when viewed from above, the recessed portion covering, when viewed from above, a center line between the interleaved electrodes adjacent to each other.

5. The liquid crystal display element as set forth in claim 2, wherein each of the projections has a tapered shape.

6. The liquid crystal display element as set forth in claim 4, wherein the recessed portion of the dielectric layer has side surfaces which are tilted with respect to a line perpendicular to the second substrate.

7. The liquid crystal display element as set forth in claim 6, wherein the recessed portion has a trapezoidal cross-section.

8. The liquid crystal display element as set forth in claim 6, wherein the recessed portion has a triangular cross-section.

9. A liquid crystal display element as set forth in claim 3, further comprising a color filter layer on said surface of the second substrate,
the dielectric layer being provided above the color filter layer.

10. The liquid crystal display element as set forth in claim 2, wherein the dielectric material is at least one of photosensitive acrylic resin, SiNx, and SiOx.

11. A liquid crystal display device comprising, as a display section, a liquid crystal display element recited in claim 1.
